(19) United States
(12) Patent Application Publication
(10) Pub. No.: US 2008/0174939 A1
(43) Pub. Date: Jul. 24, 2008

(54) NIOBIUIM SOLID ELECTROLYTIC CAPACITOR AND FABRICATION METHOD THEREOF

(75) Inventors: Yasumi KOBAYASHI, Yawata-city (JP); Kazuhiro Takatani, Takatsuki-city (JP); Mutsumi Yano, Hirakata-city (JP); Hiroshi Nonoue, Hirakata-city (JP)

Correspondence Address: DITTHAVONG MORI & STEINER, P.C., 918 Prince St., Alexandria, VA, 22314, US

(73) Assignee: Sanyo Electric Co., Ltd., Moriguchi-city (JP)

(21) Appl. No.: 12/016,673

(22) Filed: Jan. 18, 2008

(30) Foreign Application Priority Data
Jan. 19, 2007 (JP) 2007-10104
Nov. 26, 2007 (JP) 2007-304637

(51) Int. Cl. H01G 5/013; H01G 9/04

(52) U.S. Cl. 361/524; 361/528; 29/25.03

(57) ABSTRACT

A niobium solid electrolytic capacitor having an anode composed of niobium or a niobium alloy, a dielectric layer formed on a surface of the anode by anodization and containing nitrogen and fluorine, and a cathode formed on the dielectric layer. Preferably, the dielectric layer has an increasing concentration gradient of fluorine from its cathode side toward its anode side.

### BACKGROUND OF THE INVENTION

1. Technical Field

The present invention relates to a niobium solid electrolytic capacitor and a fabrication method thereof.

2. Description of Related Art

Niobium has been noted as a material of next generation for high-capacitance solid electrolytic capacitor, because its dielectric constant is about 1.8 times higher than that of tantalum as a conventional material for solid electrolytic capacitor.

However, when a solid electrolytic capacitor is mounted to a surface of a substrate, it is exposed to intense heat in a reflow soldering process. In that time, a part of oxygen in a dielectric layer composed of niobium oxide is caused to diffuse into an anode to result in a reduction in thickness of the dielectric layer. Further, this produces a defect in the dielectric layer and, as a result, increases the occurrence of leakage current in the dielectric layer.

For the purpose of suppressing such leakage current, a method is proposed in which an anode composed of niobium or a niobium alloy is anodized in an aqueous solution containing a fluorine ion and then again anodized in an aqueous solution containing phosphoric ions or sulfate ions (Japanese Patent Laid-Open No. 2005-252224). According to this method, the leakage current can be reduced to a certain degree. However, a further leakage current reduction is desired.

Japanese Patent Laid-Open No. Hei 11-329902 proposes a method in which an anode is subjected to a nitriding treatment to thereby reduce a change in capacitance of the capacitor before and after being subjected to a reflow soldering process that is carried out in mounting the niobium solid electrolytic capacitor as a component.

### SUMMARY OF THE INVENTION

It is an object of the present invention to provide a niobium solid electrolytic capacitor which can suppress leakage current that may be caused by a heating treatment such as a reflow soldering process, as well as providing a fabrication method of the niobium solid electrolytic capacitor.

The niobium solid electrolytic capacitor of the present invention includes an anode composed of niobium or a niobium alloy, a dielectric layer formed on a surface of the anode and a cathode formed on the dielectric layer. Characteristically, the dielectric layer contains nitrogen and fluorine.

In the present invention, the inclusion of nitrogen and fluorine in the dielectric layer not only reduces the occurrence of a defect inside the dielectric layer but also restrains oxygen present in the dielectric layer from partly diffusing toward the anode during a heat treatment such as a reflow soldering process. Accordingly, the present invention achieves a marked reduction of leakage current.

Also in the present invention, the dielectric layer preferably has an increasing concentration distribution (concentration gradient) of fluorine from its cathode side toward its anode side. Such concentration distribution of fluorine leads to further reduction of leakage current.

Also in the present invention, preferably, the dielectric layer further contains phosphorus. The additional inclusion of phosphorous in the dielectric layer further reduces the occurrence of a defect at a surface of the dielectric layer and accordingly further reduces leakage current.

Preferably, the phosphorus in the dielectric layer is concentrated toward the cathode side. It is particularly preferred that at least 90% of phosphorus in the dielectric layer is present in its cathode-side region that is one-tenth as thick as the dielectric layer.

In the present invention, the nitrogen content of the dielectric layer is preferably in the range of 0.01-5% by weight, more preferably 0.05-3% by weight, further preferably 0.1-2% by weight, based on the total weight of the anode and dielectric layer. If it is kept within such a range, leakage current can be further reduced.

In the present invention, the fluorine content of the dielectric layer is preferably in the range of 0.002-1% by weight, more preferably 0.01-0.7% by weight, further preferably 0.02-0.5% by weight, based on the total weight of the anode and dielectric layer. If it is kept within such a range, leakage current can be further reduced.

In the present invention, the dielectric layer may further contain phosphorus. In such a case, the phosphorous content thereof is preferably in the range of 0.0003-0.15% by weight, more preferably 0.0015-0.1% by weight, further preferably 0.003-0.06% by weight, based on the total weight of the anode and dielectric layer. If it is kept within such a range, leakage current can be further reduced.

For the niobium solid electrolytic capacitor of the present invention, a powder of niobium or a niobium alloy is preferably used having a CV value of not less than 100,000 (μF·V/g) per gram. The CV value is a product of capacitance and electrolytic voltage. If the CV value is kept within the specified range, the leakage current can be further reduced. While not particularly specified, an upper limit of the CV value is generally not greater than 500,000 (μF·V/g).

The fabrication method of the present invention is a method by which the niobium solid electrolytic capacitor of the present invention can be fabricated and is characterized as including a step of anodizing an anode composed of niobium or niobium alloy containing nitrogen in an aqueous solution containing fluorine ions.

In accordance with the fabrication method of the present invention, a niobium solid electrolytic capacitor which can suppress leakage current can be fabricated in a simple process and in an efficient manner.

In the case where the dielectric layer further containing phosphorus is fabricated, subsequent to the above anodizing step, the anode is again anodized in an aqueous solution of phosphoric acid so that phosphorus can be incorporated in the dielectric layer.

The aqueous solution containing fluorine ions in the present invention can be illustrated by an aqueous solution of ammonium fluoride, potassium fluoride, sodium fluoride, fluoric acid or the like.

While not particularly specified, the aqueous solution containing fluorine ions preferably has a fluorine ion concentration in the range of 0.01-0.10% by weight, more preferably 0.03-0.07% by weight. In the anodizing, the aqueous solution containing fluorine ions is preferably kept in the temperature range of 10-80° C., more preferably 20-50° C.

While not particularly specified, the aqueous phosphoric acid solution preferably has a concentration in the range of 0.2-5% by weight, more preferably 0.3-2% by weight. In the second anodizing, it is preferably kept in the temperature range of 40-90° C., more preferably 60-70° C.

In the present invention, various methods can be utilized to introduce nitrogen into the dielectric layer. One method involves subjecting a niobium powder or a niobium alloy powder to a nitriding treatment and then sintering the resultant to form an anode containing nitrogen. An alternative method involves sintering a niobium powder or a niobium alloy powder and then subjecting the resultant to a nitriding treatment to form an anode containing nitrogen.

The nitriding treatment temperature is preferably in the range of 200-1,000° C., more preferably 250-800° C., further preferably 300-600° C. Also, the nitriding treatment time is preferably in the range of 1 minute-1 hour, more preferably 10 minutes-40 minutes, further preferably 15 minutes-30 minutes.

The nitrogen content of the atmosphere involving the nitriding treatment is preferably 80-100%, more preferably 90-100%, further preferably 95-100%.

The niobium alloy for use in the formation of an anode can be illustrated by those comprised mainly of niobium and containing at least one of tungsten, vanadium, zinc, aluminum, molybdenum, hafnium and zirconium.

In the present invention, a conductive polymer layer and a cathode comprising a carbon layer and a silver paste layer are sequentially formed on the dielectric layer, as similar to generally-known niobium solid electrolytic capacitors.

In accordance with the present invention, the leakage current caused by an intense heat treatment such as a reflow soldering process can be reduced.

In accordance with the fabrication method of the present invention, the niobium solid electrolytic capacitor can be fabricated in a simple and efficient manner.

### BRIEF DESCRIPTION OF THE DRAWINGS

FIG. 1 is a schematic sectional view which shows an embodiment of a solid electrolytic capacitor in accordance with the present invention;

FIG. 2 is a graph which shows a composition of the dielectric layer of Example 1 in accordance with the present invention, when analyzed by XPS; and

FIG. 3 is a graph which shows a composition of the dielectric layer of Example 2 in accordance with the present invention, when analyzed by XPS.

### DESCRIPTION OF THE PREFERRED EXAMPLES

The present invention is below described in more detail by way of examples which are not intended to be limiting thereof. Suitable changes and modifications can be effected without departing from the scope of the present invention.

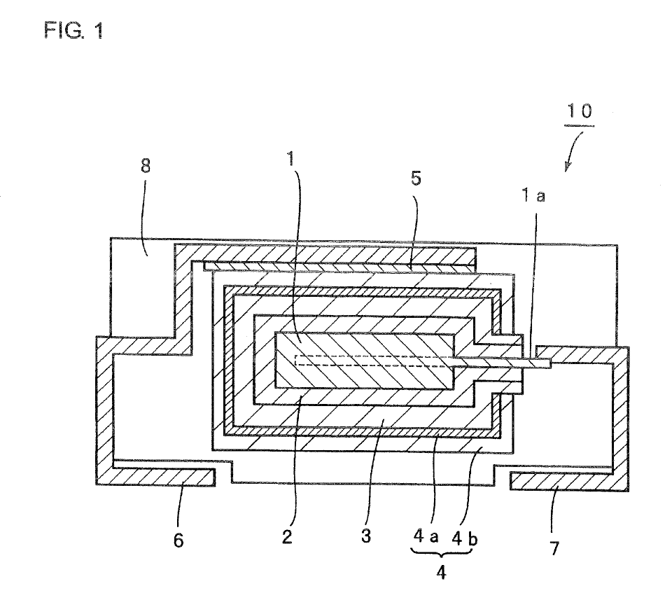

FIG. 1 is a schematic sectional view which shows an embodiment of a niobium solid electrolytic capacitor in accordance with the present invention. As shown in FIG. 1, a niobium solid electrolytic capacitor 10 comprises, in sequence, an anode 1, a dielectric layer 2, a conductive polymer layer 3, a carbon layer 4a and a silver paste layer 4b. The anode 1 comprises a porous sintered body of niobium.

The carbon layer 4a and the silver paste layer 4b constitute a cathode 4. A conductive adhesive layer 5 joins the silver paste layer 4b to an anode terminal 6. An anode lead 1a is at one end connected to a central portion of the niobium anode 1 and at the other end to an anode terminal 7. A molded casing resin 8 is configured such that the respective ends of the anode terminal 7 and cathode terminal 6 extend outwardly therefrom.

The niobium anode 1 comprises a porous sintered body of niobium particles. The dielectric layer 2 is formed on a surface of this porous sintered body and comprised chiefly of highly insulating niobium oxide (Nb₂O₅).

The conductive polymer layer 3 comprises a conductive polymer such as polypyrrole or polythiophene. In this embodiment, the conductive polymer layer 3 is used as an electrolyte layer. However, the present invention is not limited thereto. Other materials such as manganese oxides can also be used for the electrolyte layer.

The carbon layer 4a is formed by applying a carbon paste. The silver paste layer 4b is formed by applying a silver paste containing silver particles, an organic solvent and others.

Examples and Comparative Examples are given below.

### Experiment 1

### Example 1

### Step 1

First, a niobium powder having a CV value of 150,000 (μF·V/g) was subjected to a nitriding treatment at 400° C. for 20 minutes. The CV value was given by a product of a capacitance of a sintered body of niobium, subsequent to formation of an anode oxide film, and an anodizing voltage. The nitriding treatment was carried out under an atmosphere of 100% nitrogen. After the nitriding treatment, a nitrogen content of the niobium powder was analyzed according to a thermal conductivity method prescribed in JIS G1228 and determined to be 1% by weight.

The CV value for the niobium powder in the following Examples and Comparative Examples is 150,000 (μF·V/g), unless otherwise specified.

### Step 2

The niobium powder prepared in Step 1 was sintered at about 1,200° C. to form a niobium anode 1 in the form of a porous sintered body. The niobium anode 1 comprises a porous sintered body of niobium particles melt bonded to each other.

This niobium anode 1 was immersed in a 0.1 wt. % aqueous ammonium fluoride solution maintained at 60° C. and anodized at a constant current of 10V for 10 hours to thereby form a dielectric layer 2 on a surface of the anode 1.

A composition of the dielectric layer 2 was analyzed by XPS (X-ray photoelectron spectroscopy).

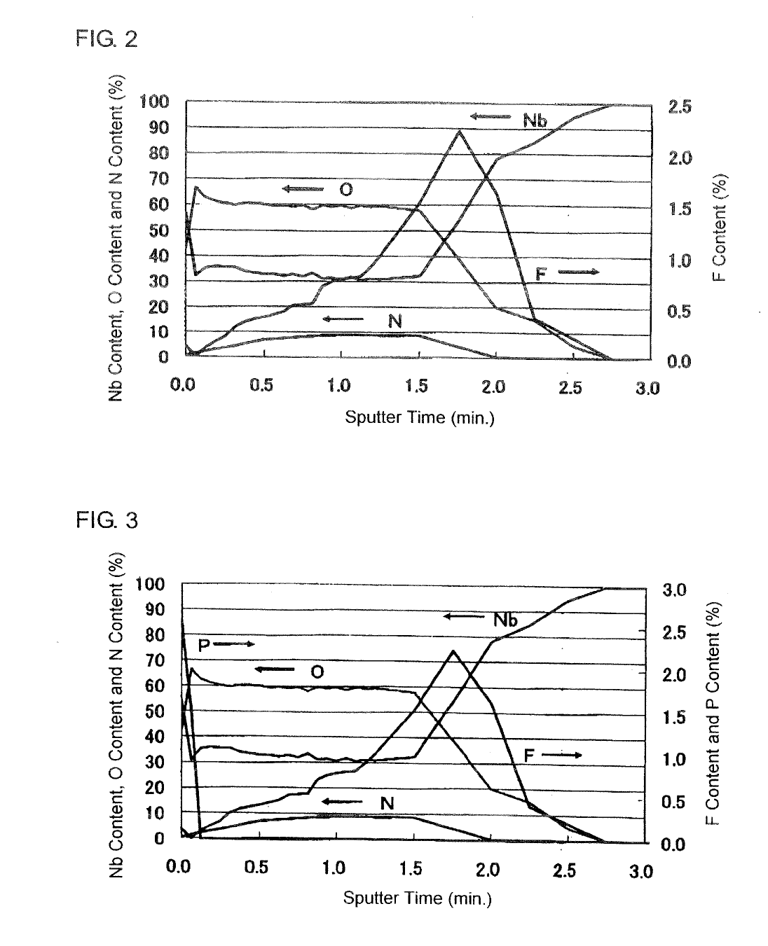

FIG. 2 is a graph which shows a composition of the dielectric layer as a result of analysis by XPS. The abscissa axis denotes a sputter time (minute) and corresponds to a thickness of the dielectric layer in the depth direction. That is, the sputter time of 0 minute represents a surface of the dielectric layer and corresponds in location to the cathode side of the dielectric layer. With the advance of the sputter time, there appears a region where an oxygen concentration in the dielectric layer starts to decrease while a concentration of niobium as an anode material starts to increase. This region approximately corresponds in location to the anode side of the dielectric layer. The respective contents (%) of Nb (niobium), O (oxygen) and N (nitrogen) in the dielectric layer are given in the left ordinate axis. The F (fluorine) content (%) of the dielectric layer is given in the right ordinate axis.

As shown in FIG. 2, the dielectric layer contains oxygen and is comprised mainly of niobium and oxygen. Nitrogen present in the dielectric layer is the one that has been introduced by the above-described nitriding treatment.

Also, the dielectric layer contains fluorine and has an increasing concentration gradient of fluorine from its cathode side toward its anode side, as shown in FIG. 2.

On the other hand, nitrogen is distributed almost uniformly throughout the dielectric layer.

The nitrogen content of the dielectric layer is 1% by weight, based on the total weight of the anode and dielectric layer, as described above.

The fluorine content of the dielectric layer is 0.24% by weight, based on the total weight of the anode and dielectric layer. This fluorine content was calculated from the nitrogen content as determined by a thermal conductivity method defined in JIS G1228 and the ratio in content of nitrogen to fluorine as determined by XPS.

### Step 3

Next, a polypyrrole film was formed on a surface of the dielectric layer 2 by a chemical polymerization method etc. to form a conductive polymer layer 3. A carbon paste and a silver paste were applied sequentially on to the conductive polymer layer 3 to form a carbon layer 4a and a silver paste layer 4b. This resulted in the formation of a solid electrolytic capacitor A1.

### Example 2

In Step 2 of Example 1, after anodized using the aqueous ammonium fluoride solution, the niobium anode was further anodized in a 1 wt. % aqueous phosphoric acid solution at 60° C. for 2 hours to form a dielectric layer. A composition of the formed dielectric layer was analyzed by XPS.

FIG. 3 is a graph which shows a composition of the dielectric layer as a result of analysis by XPS. The abscissa axis denotes a sputter time (minute) and corresponds to a thickness of the dielectric layer in the depth direction. The respective contents (%) of Nb (niobium), O (oxygen) and N (nitrogen) in the dielectric layer are given in the left ordinate axis. The respective contents (%) of F (fluorine) and P (phosphorus) in the dielectric layer are given in the right ordinate axis.

As shown in FIG. 3, in this Example, phosphorus exists on and near the surface of the dielectric layer. Phosphorus is concentrated toward the cathode side of the dielectric layer. If a thickness of the dielectric layer is defined as being equal to a depth at which the oxygen concentration decreases to 10% of a maximum value, phosphorus is heavily concentrated toward the cathode side such that at least 90% of phosphorus exists in a cathode side region which is one-tenth as thick as the dielectric layer.

As described above, the nitrogen content is 1% by weight and the fluorine content is 0.24% by weight, both based on the total weight of the anode and dielectric layer. The phosphorus content is 0.03% by weight, based on the total weight of the anode and dielectric layer. This phosphorus content was calculated from the nitrogen content determined by the thermal conductivity method prescribed in JIS G1228 and the ratio in content of nitrogen to phosphorus as determined by XPS.

Subsequently, a solid electrolytic capacitor A2 was fabricated in the same manner as in Example 1.

### Example 3

In Step 1 of Example 1 followed in Example 2, the niobium alloy powder containing 1% by weight of tungusten and 0.5% by weight of aluminum, in stead of the niobium powder, was subjected to a nitriding treatment. Otherwise, the procedure of Example 2 was followed to fabricate a solid electrolytic capacitor A3. Accordingly, the dielectric layer of this Example contains nitrogen, fluorine and phosphorus.

The nitrogen content of the dielectric layer was 1% by weight, based on the total weight of the anode and dielectric layer.

### Comparative Example 1

In Step 2 of Example 1, a 0.1 wt. % aqueous solution of nitric acid, in stead of ammonium fluoride, was used to carry out anodization. Otherwise, the procedure of Example 1 was followed to fabricate a solid electrolytic capacitor X1.

### Comparative Example 2

In Step 1 of Example 1, the nitriding treatment was not carried out. Also, in Step 2 of Example 1, a 0.1 wt. % aqueous solution of nitric acid, instead of ammonium fluoride, was used to carry out anodization. Otherwise, the procedure of Example 1 was followed to fabricate a solid electrolytic capacitor X2.

### Comparative Example 3

In Example 1, an anode was formed without carrying out the nitriding treatment in Step 1. The resulting anode was anodized in the aqueous ammonium fluoride solution in the same manner as in Example 1. Otherwise, the procedure of Example 1 was followed to fabricate a solid electrolytic capacitor Y.

### Comparative Example 4

In Example 2, an anode was formed without carrying out the nitriding treatment in Step 1. The resulting anode was anodized in the aqueous ammonium fluoride solution and in the aqueous phosphoric acid solution. Otherwise, the procedure of Example 2 was followed to fabricate a solid electrolytic capacitor Z.

### Evaluation of Capacitors

The above-fabricated solid electrolytic capacitors A1, A2, X1, X2, Y and Z were measured for leakage current. The leakage current was determined by subjecting each capacitor to a heat treatment at 250° C. for 10 minutes, applying thereto a voltage of 5 V and measuring a current value after a lapse of 20 seconds.

The measurement results are shown in Table 1.

The leakage current values shown in Table 1 are given by index numbers when that of the capacitor A1 is taken as 100.

TABLE 1

| | Leakage Current |
|---|---|
| Solid Electrolytic Capacitor A1 | 100 |
| Solid Electrolytic Capacitor A2 | 70 |
| Solid Electrolytic Capacitor A3 | 68 |
| Solid Electrolytic Capacitor X1 | 500 |
| Solid Electrolytic Capacitor X2 | 500 |
| Solid Electrolytic Capacitor Y | 200 |
| Solid Electrolytic Capacitor Z | 150 |

The capacitor X1 containing nitrogen alone shows little leakage current improvement over the capacitor X2 containing no nitrogen in the dielectric layer. This demonstrates that the leakage current reducing effect is little obtained by the inclusion of nitrogen alone in the dielectric layer.

The better leakage current reducing effect over the capacitor X2 is obtained for the capacitor Y containing fluorine alone in the dielectric layer. Also, the capacitor Z containing fluorine and phosphorus alone shows the reduced leakage current compared to the capacitor X2 containing none in the dielectric layer.

The capacitor A1 containing nitrogen and fluorine, in accordance with the present invention, shows the further reduced leakage current compared to the capacitor Y containing fluorine alone in its dielectric layer. This is presumably because the inclusion of fluorine and nitrogen, instead of fluorine alone, in the dielectric layer further reduces leakage current by a synergistic effect.

Also, the capacitor A2 containing nitrogen, fluorine and phosphorus, in accordance with the present invention, shows the further reduced leakage current compared to the capacitor Z containing fluorine and phosphorus in its dielectric layer. This is presumably because the inclusion of nitrogen in addition to fluorine and phosphorus in the dielectric layer further reduces leakage current by a synergistic effect.

As can be seen from comparison between the capacitors A1 and A2, the further leakage current reduction is attained by additional inclusion of phosphorus in the dielectric layer.

### Experiment 2

This Experiment was conducted to study the influence of the nitrogen content of the dielectric layer on reduction of leakage current.

### Example 4

In Step 1 of Example 1, the niobium powder was subjected to a nitriding treatment at 400° C. for 1 minute. Otherwise, the procedure of Example 1 was followed to fabricate a solid electrolytic capacitor A4. Accordingly, the dielectric layer of this Example contains nitrogen and fluorine.

The nitrogen content was 0.01% by weight, based on the total weight of the anode and dielectric layer.

### Example 5

In Step 1 of Example 1, the niobium powder was subjected to a nitriding treatment at 400° C. for 10 minutes. Otherwise, the procedure of Example 1 was followed to fabricate a solid electrolytic capacitor A5. Accordingly, the dielectric layer of this Example contains nitrogen and fluorine.

The nitrogen content was 0.05% by weight, based on the total weight of the anode and dielectric layer.

### Example 6

In Step 1 of Example 1 the niobium powder was subjected to a nitriding treatment at 400° C. for 15 minutes. Otherwise, the procedure of Example 1 was followed to fabricate a solid electrolytic capacitor A6. Accordingly, the dielectric layer of this Example contains nitrogen and fluorine.

The nitrogen content was 0.1% by weight, based on the total weight of the anode and dielectric layer.

### Example 7

In Step 1 of Example 1, the niobium powder was subjected to a nitriding treatment at 400° C. for 30 minutes. Otherwise, the procedure of Example 1 was followed to fabricate a solid electrolytic capacitor A7. Accordingly, the dielectric layer of this Example contains nitrogen and fluorine.

The nitrogen content was 2% by weight, based on the total weight of the anode and dielectric layer.

### Example 8

In Step 1 of Example 1, the niobium powder was subjected to a nitriding treatment at 400° C. for 40 minutes. Otherwise, the procedure of Example 1 was followed to fabricate a solid electrolytic capacitor A8. Accordingly, the dielectric layer of this Example contains nitrogen and fluorine.

The nitrogen content was 3% by weight, based on the total weight of the anode and dielectric layer.

### Example 9

In Step 1 of Example 1, the niobium powder was subjected to a nitriding treatment at 400° C. for 60 minutes. Otherwise, the procedure of Example 1 was followed to fabricate a solid electrolytic capacitor A9. Accordingly, the dielectric layer of this Example contains nitrogen and fluorine.

The nitrogen content was 5% by weight, based on the total weight of the anode and dielectric layer.

### Example 10

In Step 1 of Example 1, the niobium powder was subjected to a nitriding treatment at 400° C. for 90 minutes. Otherwise, the procedure of Example 1 was followed to fabricate a solid electrolytic capacitor A10. Accordingly, the dielectric layer of this Example contains nitrogen and fluorine.

The nitrogen content was 10% by weight, based on the total weight of the anode and dielectric layer.

### Evaluation of Capacitors

The above-fabricated solid electrolytic capacitors were measured for leakage current in the same manner as in Experiment 1.

The measurement results are shown in Table 2. The leakage current values are given by index numbers when that of the capacitor A1 is taken as 100. In Table 2, the leakage current values for the capacitors Y and A1 are also shown.

TABLE 2

| | Nitrogen Content | |
|---|---|---|
| | (% by weight) | Leakage Current |
| Solid Electrolytic Capacitor Y | 0.00 | 200 |
| Solid Electrolytic Capacitor A4 | 0.01 | 150 |
| Solid Electrolytic Capacitor A5 | 0.05 | 132 |
| Solid Electrolytic Capacitor A6 | 0.10 | 115 |
| Solid Electrolytic Capacitor A1 | 1.00 | 100 |
| Solid Electrolytic Capacitor A7 | 2.00 | 117 |
| Solid Electrolytic Capacitor A8 | 3.00 | 129 |
| Solid Electrolytic Capacitor A9 | 5.00 | 148 |
| Solid Electrolytic Capacitor A10 | 10.00 | 190 |

As can be clearly seen from the results shown in Table 2, the leakage current can be markedly reduced if the nitrogen content of the dielectric layer is kept within the range of 0.01-5% by weight, preferably 0.05-3% by weight, more preferably 0.1-2% by weight, based on the total weight of the anode and dielectric layer.

### Example 11

In Step 1 of Example 1 followed in Example 2, the niobium powder was subjected to a nitriding treatment at 400° C. for 1 minute. Otherwise, the procedure of Example 2 was followed to fabricate a solid electrolytic capacitor A11. Accordingly, the dielectric layer of this Example contains nitrogen, fluorine and phosphorus.

The nitrogen content of the dielectric layer was 0.01% by weight, based on the total weight of the anode and dielectric layer.

### Example 12

In Step 1 of Example 1 followed in Example 2, the niobium powder was subjected to a nitriding treatment at 400° C. for 10 minutes. Otherwise, the procedure of Example 2 was followed to fabricate a solid electrolytic capacitor A12. Accordingly, the dielectric layer of this Example contains nitrogen, fluorine and phosphorus.

The nitrogen content of the dielectric layer was 0.05% by weight, based on the total weight of the anode and dielectric layer.

### Example 13

In Step 1 of Example 1 followed in Example 2, the niobium powder was subjected to a nitriding treatment at 400° C. for 15 minutes. Otherwise, the procedure of Example 2 was followed to fabricate a solid electrolytic capacitor A13. Accordingly, the dielectric layer of this Example contains nitrogen, fluorine and phosphorus.

The nitrogen content of the dielectric layer was 0.1% by weight, based on the total weight of the anode and dielectric layer.

### Example 14

In Step 1 of Example 1 followed in Example 2, the niobium powder was subjected to a nitriding treatment at 400° C. for 30 minutes. Otherwise, the procedure of Example 2 was followed to fabricate a solid electrolytic capacitor A14. Accordingly, the dielectric layer of this Example contains nitrogen, fluorine and phosphorus.

The nitrogen content of the dielectric layer was 2% by weight, based on the total weight of the anode and dielectric layer.

### Example 15

In Step 1 of Example 1 followed in Example 2, the niobium powder was subjected to a nitriding treatment at 400° C. for 40 minutes. Otherwise, the procedure of Example 2 was followed to fabricate a solid electrolytic capacitor A15. Accordingly, the dielectric layer of this Example contains nitrogen, fluorine and phosphorus.

The nitrogen content of the dielectric layer was 3% by weight, based on the total weight of the anode and dielectric layer.

### Example 16

In Step 1 of Example 1 followed in Example 2, the niobium powder was subjected to a nitriding treatment at 400° C. for 60 minute. Otherwise, the procedure of Example 2 was followed to fabricate a solid electrolytic capacitor A16. Accordingly, the dielectric layer of this Example contains nitrogen, fluorine and phosphorus.

The nitrogen content of the dielectric layer was 5% by weight, based on the total weight of the anode and dielectric layer.

### Example 17

In Step 1 of Example 1 followed in Example 2, the niobium powder was subjected to a nitriding treatment at 400° C. for 90 minute. Otherwise, the procedure of Example 2 was followed to fabricate a solid electrolytic capacitor A17. Accordingly, the dielectric layer of this Example contains nitrogen, fluorine and phosphorus.

The nitrogen content of the dielectric layer was 10% by weight, based on the total weight of the anode and dielectric layer.

### Evaluation of Capacitors

The above-fabricated solid electrolytic capacitors were measured for leakage current in the same manner as in Experiment 1.

The measurement results are shown in Table 3. The leakage current values are given by index numbers when that of the capacitor A1 is taken as 100. In Table 3, the leakage current values for the capacitors Z and A2 are also shown.

TABLE 3

| | Nitrogen Content | |
|---|---|---|
| | (% by weight) | Leakage Current |
| Solid Electrolytic Capacitor Z | 0.00 | 150 |
| Solid Electrolytic Capacitor A11 | 0.01 | 118 |
| Solid Electrolytic Capacitor A12 | 0.05 | 112 |
| Solid Electrolytic Capacitor A13 | 0.10 | 100 |
| Solid Electrolytic Capacitor A2 | 1.00 | 70 |
| Solid Electrolytic Capacitor A14 | 2.00 | 99 |
| Solid Electrolytic Capacitor A15 | 3.00 | 112 |
| Solid Electrolytic Capacitor A16 | 5.00 | 117 |
| Solid Electrolytic Capacitor A17 | 10.00 | 145 |

As can be clearly seen from the results shown in Table 3, the leakage current can be markedly reduced if the nitrogen content of the dielectric layer is kept within the range of 0.01-5% by weight, preferably 0.05-3% by weight, more preferably 0.1-2% by weight, based on the total weight of the anode and dielectric layer.

### Experiment 3

This Experiment was conducted to study the influence of the CV value, a product of a capacitance of a sintered body of niobium, subsequent to formation of an anode oxide film, and an anodizing voltage, on reduction of leakage current.

### Example 18

A niobium powder having a CV value of 100,000 (μF·V/g) was used. The formation voltage was set at 6.7 V such that the capacitance was brought to a value common to the other Examples. Otherwise, the procedure of Example 1 was followed to fabricate a solid electrolytic capacitor A18.

The nitrogen content was 1% by weight and the fluorine content was 0.24% by weight, both based on the total weight of the anode and dielectric layer.

### Example 19

A niobium powder having a CV value of 80,000 (μF·V/g) was used. The formation voltage was set at 5.3 V such that the capacitance was brought to a value common to the other Examples. Otherwise, the procedure of Example 1 was followed to fabricate a solid electrolytic capacitor A19.

The nitrogen content was 1% by weight and the fluorine content was 0.24% by weight, both based on the total weight of the anode and dielectric layer.

### Evaluation Of Capacitors

The procedure of Experiment 1 was followed to measure leakage current for the above-fabricated solid electrolytic capacitors, with the exception that leakage current of each capacitor was measured at half the anodization voltage. The measurement results are shown in Table 4. The leakage current values are given by index numbers when that of the capacitor A1 is taken as 100. In Table 4, the leakage current value for the capacitor A1 is also shown.

TABLE 4

| | CV Value | |
|---|---|---|
| | (μF · V/g) | Leakage Current |
| Solid Electrolytic Capacitor A19 | 80,000 | 140 |
| Solid Electrolytic Capacitor A18 | 100,000 | 120 |
| Solid Electrolytic Capacitor A1 | 150,000 | 100 |

As can be clearly seen from the results shown in Table 4, the leakage current can be markedly reduced if the CV value is increased to 100,000 (μF·V/g) or above.

### Example 20

A niobium powder having a CV value of 100,000 (μF·V/g) was used. The formation voltage was set at 6.7 V such that the capacitance was brought to a value common to the other Examples. Otherwise, the procedure of Example 2 was followed to fabricate a solid electrolytic capacitor A20.

The nitrogen content, fluorine content and phosphorus content were 1% by weight, 0.24% by weight and 0.03% by weight, respectively, all based on the total weight of the anode and dielectric layer.

### Example 21

A niobium powder having a CV value of 80,000 (μF·V/g) was used. The formation voltage was set at 5.3 V such that the capacitance was brought to a value common to the other Examples. Otherwise, the procedure of Example 2 was followed to fabricate a solid electrolytic capacitor A21.

The nitrogen content, fluorine content and phosphorus content were 1% by weight, 0.24% by weight and 0.03% by weight, respectively, all based on the total weight of the anode and dielectric layer.

### Evaluation of Capacitors

The procedure of Experiment 1 was followed to measure leakage current for the above-fabricated solid electrolytic capacitors.

The measurement results are shown in Table 5. The leakage current values are given by index numbers when that of the capacitor A1 is taken as 100. In Table 5, the leakage current value for the capacitor A2 is also shown.

TABLE 5

| | CV Value | |
|---|---|---|
| | (μF · V/g) | Leakage Current |
| Solid Electrolytic Capacitor A21 | 80,000 | 120 |
| Solid Electrolytic Capacitor A20 | 100,000 | 100 |
| Solid Electrolytic Capacitor A2 | 150,000 | 70 |

As can be clearly seen from the results shown in Table 5, the leakage current can be markedly reduced when the CV value is increased to 100,000 (μF·V/g) or above.

### Experiment 4

This Experiment was conducted to study the influence of the fluorine content on reduction of leakage current.

### Example 22

In Step 2 of Example 1, the concentration of the aqueous ammonium fluoride solution was altered to 0.01% by weight. Otherwise, the procedure of Example 1 was followed to fabricate a solid electrolytic capacitor A22. The fluorine content was 0.001% by weight, based on the total weight of the anode and dielectric layer.

### Example 23

In Step 2 of Example 1, the concentration of the aqueous ammonium fluoride solution was altered to 0.02% by weight. Otherwise, the procedure of Example 1 was followed to fabricate a solid electrolytic capacitor A23. The fluorine content was 0.002% by weight, based on the total weight of the anode and dielectric layer.

### Example 24

In Step 2 of Example 1, the concentration of the aqueous ammonium fluoride solution was altered to 0.06% by weight. Otherwise, the procedure of Example 1 was followed to fabricate a solid electrolytic capacitor A24. The fluorine content was 0.01% by weight, based on the total weight of the anode and dielectric layer.

### Example 25

In Step 2 of Example 1, the concentration of the aqueous ammonium fluoride solution was altered to 0.08% by weight. Otherwise, the procedure of Example 1 was followed to fabricate a solid electrolytic capacitor A25. The fluorine content was 0.02% by weight, based on the total weight of the anode and dielectric layer.

### Example 26

In Step 2 of Example 1, the concentration of the aqueous ammonium fluoride solution was altered to 0.12% by weight. Otherwise, the procedure of Example 1 was followed to fabricate a solid electrolytic capacitor A26. The fluorine content was 0.5% by weight, based on the total weight of the anode and dielectric layer.

### Example 27

In Step 2 of Example 1, the concentration of the aqueous ammonium fluoride solution was altered to 0.14% by weight. Otherwise, the procedure of Example 1 was followed to fabricate a solid electrolytic capacitor A27. The fluorine content was 0.7% by weight, based on the total weight of the anode and dielectric layer.

### Example 28

In Step 2 of Example 1, the concentration of the aqueous ammonium fluoride solution was altered to 0.2% by weight. Otherwise, the procedure of Example 1 was followed to fabricate a solid electrolytic capacitor A28. The fluorine content was 1% by weight, based on the total weight of the anode and dielectric layer.

### Example 29

In Step 2 of Example 1, the concentration of the aqueous ammonium fluoride solution was altered to 0.3% by weight. Otherwise, the procedure of Example 1 was followed to fabricate a solid electrolytic capacitor A29. The fluorine content was 2% by weight, based on the total weight of the anode and dielectric layer.

### Evaluation of Capacitors

The procedure of Experiment 1 was followed to measure leakage current for the above-fabricated solid electrolytic capacitors.

The measurement results are shown in Table 6. The leakage current values are given by index numbers when that of the capacitor A1 is taken as 100. In Table 6, the leakage current value for the capacitor A1 is also shown.

TABLE 6

| | Fluorine Content | |
|---|---|---|
| | (% by weight) | Leakage Current |
| Solid Electrolytic Capacitor A22 | 0.001 | 149 |
| Solid Electrolytic Capacitor A23 | 0.002 | 130 |
| Solid Electrolytic Capacitor A24 | 0.010 | 125 |
| Solid Electrolytic Capacitor A25 | 0.020 | 110 |
| Solid Electrolytic Capacitor A1 | 0.240 | 100 |
| Solid Electrolytic Capacitor A26 | 0.500 | 110 |
| Solid Electrolytic Capacitor A27 | 0.700 | 120 |
| Solid Electrolytic Capacitor A28 | 1.000 | 130 |
| Solid Electrolytic Capacitor A29 | 2.000 | 148 |

As can be clearly seen from the results shown in Table 6, the leakage current can be markedly reduced if the fluorine content is kept within the range of 0.002-1% by weight, based on the total weight of the anode and dielectric layer.

### Example 30

In Step 2 of Example 1 followed in Example 2, the concentration of the aqueous ammonium fluoride solution was altered to 0.01% by weight. Otherwise, the procedure of Example 2 was followed to fabricate a solid electrolytic capacitor A30. The fluorine content was 0.001% by weight, based on the total weight of the anode and dielectric layer.

### Example 31

In Step 2 of Example 1 followed in Example 2, the concentration of the aqueous ammonium fluoride solution was altered to 0.02% by weight. Otherwise, the procedure of Example 2 was followed to fabricate a solid electrolytic capacitor A31. The fluorine content was 0.002% by weight, based on the total weight of the anode and dielectric layer.

### Example 32

In Step 2 of Example 1 followed in Example 2, the concentration of the aqueous ammonium fluoride solution was altered to 0.06% by weight. Otherwise, the procedure of Example 2 was followed to fabricate a solid electrolytic capacitor A32. The fluorine content was 0.01% by weight, based on the total weight of the anode and dielectric layer.

### Example 33

In Step 2 of Example 1 followed in Example 2, the concentration of the aqueous ammonium fluoride solution was altered to 0.08% by weight. Otherwise, the procedure of Example 2 was followed to fabricate a solid electrolytic capacitor A33. The fluorine content was 0.02% by weight, based on the total weight of the anode and dielectric layer.

### Example 34

In Step 2 of Example 1 followed in Example 2, the concentration of the aqueous ammonium fluoride solution was altered to 0.12% by weight. Otherwise, the procedure of Example 2 was followed to fabricate a solid electrolytic capacitor A34. The fluorine content was 0.5% by weight, based on the total weight of the anode and dielectric layer.

### Example 35

In Step 2 of Example 1 followed in Example 2, the concentration of the aqueous ammonium fluoride solution was altered to 0.14% by weight. Otherwise, the procedure of Example 2 was followed to fabricate a solid electrolytic capacitor A35. The fluorine content was 0.7% by weight, based on the total weight of the anode and dielectric layer.

### Example 36

In Step 2 of Example 1 followed in Example 2, the concentration of the aqueous ammonium fluoride solution was altered to 0.2% by weight. Otherwise, the procedure of Example 2 was followed to fabricate a solid electrolytic capacitor A36. The fluorine content was 1% by weight, based on the total weight of the anode and dielectric layer.

### Example 37

In Step 2 of Example 1 followed in Example 2, the concentration of the aqueous ammonium fluoride solution was altered to 0.3% by weight. Otherwise, the procedure of Example 2 was followed to fabricate a solid electrolytic capacitor A37. The fluorine content was 2% by weight, based on the total weight of the anode and dielectric layer.

### Evaluation of Capacitors

The procedure of Experiment 1 was followed to measure leakage current for the above-fabricated solid electrolytic capacitors.

The measurement results are shown in Table 7. The leakage current values are given by index numbers when that of the capacitor A1 is taken as 100. In Table 7, the leakage current value for the capacitor A2 is also shown.

TABLE 7

| | Fluorine Content | |
|---|---|---|
| | (% by weight) | Leakage Current |
| Solid Electrolytic Capacitor A30 | 0.001 | 149 |
| Solid Electrolytic Capacitor A31 | 0.002 | 110 |
| Solid Electrolytic Capacitor A32 | 0.010 | 100 |
| Solid Electrolytic Capacitor A33 | 0.020 | 75 |
| Solid Electrolytic Capacitor A2 | 0.240 | 70 |
| Solid Electrolytic Capacitor A34 | 0.500 | 75 |
| Solid Electrolytic Capacitor A35 | 0.700 | 101 |
| Solid Electrolytic Capacitor A36 | 1.000 | 110 |
| Solid Electrolytic Capacitor A37 | 2.000 | 148 |

As can be clearly seen from the results shown in Table 7, the leakage current can be markedly reduced if the fluorine content is kept within the range of 0.002-1% by weight, based on the total weight of the anode and dielectric layer.

### Experiment 5

This Experiment was conducted to study the influence of the phosphorus content on reduction of leakage current.

### Example 38

In Step 2 of Example 1 followed in Example 2, the concentration of the aqueous phosphoric acid solution was altered to 0.1% by weight. Otherwise, the procedure of Example 2 was followed to fabricate a solid electrolytic capacitor A38. The phosphorus content was 0.0001% by weight, based on the total weight of the anode and dielectric layer.

### Example 39

In Step 2 of Example 1 followed in Example 2, the concentration of the aqueous phosphoric acid solution was altered to 0.2% by weight. Otherwise, the procedure of Example 2 was followed to fabricate a solid electrolytic capacitor A39. The phosphorus content was 0.0003% by weight, based on the total weight of the anode and dielectric layer.

### Example 40

In Step 2 of Example 1 followed in Example 2, the concentration of the aqueous phosphoric acid solution was altered to 0.3% by weight. Otherwise, the procedure of Example 2 was followed to fabricate a solid electrolytic capacitor A40. The phosphorus content was 0.0015% by weight, based on the total weight of the anode and dielectric layer.

### Example 41

In Step 2 of Example 1 followed in Example 2, the concentration of the aqueous phosphoric acid solution was altered to 0.5% by weights. Otherwise, the procedure of Example 2 was followed to fabricate a solid electrolytic capacitor A41. The phosphorus content was 0.0030% by weight, based on the total weight of the anode and dielectric layer.

### Example 42

In Step 2 of Example 1 followed in Example 2, the concentration of the aqueous phosphoric acid solution was altered to 1.5% by weight. Otherwise, the procedure of Example 2 was followed to fabricate a solid electrolytic capacitor A42. The phosphorus content was 0.06% by weight, based on the total weight of the anode and dielectric layer.

### Example 43

In Step 2 of Example 1 followed in Example 2, the concentration of the aqueous phosphoric acid solution was altered to 2% by weight. Otherwise, the procedure of Example 2 was followed to fabricate a solid electrolytic capacitor A43. The phosphorus content was 0.1% by weight, based on the total weight of the anode and dielectric layer.

### Example 44

In Step 2 of Example 21 followed in Example, the concentration of the aqueous phosphoric acid solution was altered to 5% by weight. Otherwise, the procedure of Example 2 was followed to fabricate a solid electrolytic capacitor A44. The phosphorus content was 0.15% by weight, based on the total weight of the anode and dielectric layer.

### Example 45

In Step 2 of Example 1 followed in Example 2, the concentration of the aqueous phosphoric acid solution was altered to 10% by weight. Otherwise, the procedure of Example 2 was followed to fabricate a solid electrolytic capacitor A45. The phosphorus content was 0.3% by weight, based on the total weight of the anode and dielectric layer.

### Evaluation of Capacitors

The procedure of Experiment 1 was followed to measure leakage current for the above-fabricated solid electrolytic capacitors.

The measurement results are shown in Table 8. The leakage current values are given by index numbers when that of the capacitor A1 is taken as 100. In Table 8, the leakage current value for the capacitor A2 is also shown.

TABLE 8

| | Phosphorus Content | |
|---|---|---|
| | (% by weight) | Leakage Current |
| Solid Electrolytic Capacitor A38 | 0.0001 | 147 |
| Solid Electrolytic Capacitor A39 | 0.0003 | 113 |
| Solid Electrolytic Capacitor A40 | 0.0015 | 96 |
| Solid Electrolytic Capacitor A41 | 0.0030 | 74 |
| Solid Electrolytic Capacitor A2 | 0.0300 | 70 |
| Solid Electrolytic Capacitor A42 | 0.0600 | 78 |
| Solid Electrolytic Capacitor A43 | 0.1000 | 99 |
| Solid Electrolytic Capacitor A44 | 0.1500 | 114 |
| Solid Electrolytic Capacitor A45 | 0.3000 | 149 |

As can be clearly seen from the results shown in Table 8, the leakage current can be markedly reduced if the phosphorus content is kept within the range of 0.003-0.15% by weight, based on the total weight of the anode and dielectric layer.

What is claimed is:

1. A niobium solid electrolytic capacitor comprising:
an anode comprising niobium or a niobium alloy;
a dielectric layer formed on a surface of said anode, said dielectric layer containing nitrogen and fluorine; and
a cathode formed on the dielectric layer.

2. The niobium solid electrolytic capacitor as recited in claim 1, wherein said dielectric layer has an increasing concentration distribution of said fluorine from its cathode side toward its anode side.

3. The niobium solid electrolytic capacitor as recited in claim 1, wherein said dielectric layer further contains phosphorus.

4. The niobium solid electrolytic capacitor as recited in claim 3, wherein said phosphorus in the dielectric layer is concentrated toward said cathode side.

5. The niobium solid electrolytic capacitor as recited in claim 1, wherein a content of said nitrogen in the dielectric layer is in the range of 0.05-3% by weight, based on the total weight of said anode and dielectric layer.

6. The niobium solid electrolytic capacitor as recited in claim 1, wherein said anode comprises a niobium powder or a niobium alloy powder having a CV value of not less than 100,000 (μF·V/g) per gram, said CV value being a product of capacitance and electrolytic voltage.

7. A method for fabrication of the niobium solid electrolytic capacitor recited in claim 1, said method including a step of anodizing an anode comprising niobium or niobium alloy containing nitrogen in an aqueous solution containing fluorine ions.

8. A method for fabrication of the niobium solid electrolytic capacitor recited in claim 3, said method including a step of anodizing an anode comprising niobium or niobium alloy containing nitrogen in an aqueous solution containing fluorine ions and then again anodizing said anode in an aqueous phosphoric acid solution.

9. The method for fabrication of the niobium solid electrolytic capacitor as recited in claim 7, wherein said method includes a step of nitriding a niobium powder or a niobium alloy powder and sintering the nitrided powder to form said anode containing nitrogen or a step of sintering a niobium powder or a niobium alloy powder and nitriding the sintered powder to form the anode containing nitrogen.

10. The method for fabrication of the niobium solid electrolytic capacitor as recited in claim 8, wherein said method includes a step of nitriding a niobium powder or a niobium alloy powder and sintering the nitrided powder to form said anode containing nitrogen or a step of sintering a niobium powder or a niobium alloy powder and nitriding the sintered powder to form the anode containing nitrogen.
